(19) United States
(12) Patent Application Publication
(10) Pub. No.: US 2013/0077066 A1
(43) Pub. Date: Mar. 28, 2013

(54) PATTERN FORMING APPARATUS

(71) Applicants: Ryoichi INANAMI, Yokohama-shi (JP); Tetsuro Nakasugi, Yokohama-shi (JP)

(72) Inventors: Ryoichi INANAMI, Yokohama-shi (JP); Tetsuro Nakasugi, Yokohama-shi (JP)

(21) Appl. No.: 13/428,519

(22) Filed: Mar. 23, 2012

(30) Foreign Application Priority Data
Sep. 22, 2011 (JP) 2011-207681

(51) Int. Cl. G03B 27/74

(52) U.S. Cl. 355/53; 355/77

(57) ABSTRACT

According to one embodiment, a pattern forming apparatus includes a stage provided under a lower surface of a substrate, a probe provided above an upper surface of the substrate, a drive unit which drives at least one of the stage and the probe, a monitor/lithography unit connected to the probe, and a control unit which controls the drive unit and the monitor/lithography unit. The control unit is configured to change a relative position between the probe and the substrate, and form a first pattern in an area direct above a second pattern after detecting the first pattern in the substrate by the probe.

### CROSS-REFERENCE TO RELATED APPLICATIONS

This application is based upon and claims the benefit of priority from prior Japanese Patent Application No. 2011-207681, filed Sep. 22, 2011, the entire contents of which are incorporated herein by reference.

### FIELD

Embodiments described herein relate generally to a pattern forming apparatus.

### BACKGROUND

There are known probe lithography technologies which form a micropattern of a nanometer level using a microprobe used in an atomic force microscope, a tunnel current microscope, and the like. For example, an anode oxidation method, electron beam lithography, and further a method of forming a pattern by dropping a small amount of solution from a tip of a probe, a method of depositing a material adsorbed to a tip of a probe on a substrate, and the like are one of the probe lithography technologies.

When a micropattern is formed using the technology, an alignment with an already formed base pattern becomes a problem. That is, although the alignment is generally executed by detecting an alignment mark formed in the same layer as a base pattern or in a layer below the same layer, in a conventional probe lithography technology, an alignment mark formed in a surface in which a micropattern is formed is used. Moreover, an area in which the micropattern is formed is away from a position of the alignment mark. Accordingly, after the alignment mark is detected by a probe, the probe must be moved from on the alignment mark to an area in which the micropattern is formed.

Then, since the movement is executed by mechanically moving a probe or a stage in a pattern forming apparatus, even if the position of the alignment mark is accurately detected, a sufficient alignment accuracy may not be obtained between the micropattern and base pattern.

### BRIEF DESCRIPTION OF THE DRAWINGS

FIG. 1 is a view showing a first embodiment of a pattern forming apparatus;

FIG. 2 is a flowchart showing a pattern forming process;

FIG. 3 is a flowchart showing a pattern forming process;

FIG. 4 is a view showing a process which forms a micropattern to a resist layer;

FIG. 5 is a view showing an example which detects a base pattern by measuring a capacitance;

FIG. 6 is a view showing a process which forms a micropattern to a resist layer;

FIG. 7 is a view showing a process which directly forms a micropattern;

FIG. 8 is a view showing a second embodiment of the pattern forming apparatus;

FIG. 9 is a flowchart showing a pattern forming process;

FIG. 10 is a flowchart showing a pattern forming process;

FIG. 11 is a view showing a third embodiment of the pattern forming apparatus;

FIG. 12 is a view showing a process which forms a micropattern to a resist layer; and

FIG. 13 is a view showing a process which detects a micropattern for an adjustment.

### DETAILED DESCRIPTION

In general, according to one embodiment, a pattern forming apparatus comprising: a stage placed under a lower surface of a substrate; a probe placed above an upper surface of the substrate; a drive unit which drives at least one of the stage and the probe; a monitor/lithography unit connected to the probe; and a control unit which controls the drive unit and the monitor/lithography unit, wherein the control unit is configured to change a relative position between the probe and the substrate, and form a first pattern in an area direct above a second pattern after detecting the second pattern in the substrate by the probe.

Embodiments will be explained below referring to the drawings.

A probe lithography technology is a technology which forms a pattern using a probe. A problem of the technology resides in that a constant period is necessary until a micropattern is actually lithographed after an alignment to a substrate to be processed is executed for forming a micropattern by scanning probe. That is, since an operation which mechanically moves the probe or a stage within the constant period is accompanied, a problem arises in that a sufficient alignment accuracy cannot be obtained between a micropattern and a base pattern.

Thus, in the following embodiments, a pattern forming apparatus which can improve an alignment accuracy in the probe lithography technology by a common feature that a micropattern is formed on a base pattern immediately after the base pattern (including an alignment mark) is detected will be explained.

Herein, a base pattern and a micropattern are defined as follows. The micropattern is a pattern formed by the pattern forming apparatus of the embodiments and the base pattern is a pattern acting as a base of the micropattern and is a pattern in which an alignment becomes necessary to form the micropattern.

### 1. First Embodiment

A first embodiment relates to a pattern forming apparatus which can form a micropattern (first pattern) in an area directly above a base pattern (second pattern) after the base pattern is detected by one probe.

FIG. 1 shows a first embodiment of the pattern forming apparatus.

Stage 11 is provided under a lower surface of substrate (substrate to be processed) 12. Stage 11 has a function which supports substrate 12 and applies a fixed potential (for example, positive potential) to a lower surface of substrate 12. Substrate 12 is, for example, a semiconductor wafer.

Probe 13 is provided above an upper surface of substrate 12. Although probe 13 has, for example, a cantilever type, it is not limited thereto.

Drive units 14, 15 drive at least one of stage 11 and probe 13. When only stage 11 is driven, drive unit 15 may be omitted. Further, when only probe 13 is driven, drive unit 14 may be omitted. Naturally, both stage 11 and probe 13 may be driven using drive units 14, 15.

Drive unit 14 drives stage 11. For example, drive unit 14 two-dimensionally drives stage 11. However, it is also possible to drive stage 11 by drive unit 14 one-dimensionally or three-dimensionally.

Drive unit 15 drives probe 13. For example, drive unit 15 three-dimensionally drives probe 13. However, it is also possible to drive probe 13 by drive unit 15 one-dimensionally or two-dimensionally.

Monitor/lithography unit 16 is electrically connected to probe 13 to detect the base pattern in substrate 12 and to form the micropattern in an area directly above the base pattern. For example, monitor/lithography unit 16 detects the base pattern in substrate 12 by detecting a capacitance between stage 11 and probe 13.

When the base pattern is detected by the capacitance, monitor/lithography unit 16 applies an alternate current voltage between, for example, stage 11 and probe 13 and detects its current waveform. Further, when the micropattern is formed, monitor/lithography unit 16 applies a voltage between, for example, stage 11 and probe 13.

Note that it is also possible to detect the base pattern by a physical factor other than the capacitance, for example, a surface potential, a magnetic field, and the like.

Control unit 17 controls drive units 14, 15 and monitor/lithography unit 16. Control unit 17 changes a relative position between substrate 12 and probe 13. For example, control unit 17 controls drive units 14, 15 so that probe 13 executes scanning linearly to substrate 12.

Further, after the base pattern in substrate 12 is detected by probe 13, control unit 17 forms the micropattern in an area directly above the base pattern.

For example, after one base pattern is detected, at once, one micropattern may be lithographed in an area directly above the one base pattern and further after base patterns are detected, micropatterns may be lithographed in areas directly above the respective base patterns.

What is important here is to lithograph the micropattern in the area directly above the base pattern detected by probe 13. That is, a position directly above the base pattern can be detected and the micropattern can be formed directly above the base pattern.

With the operation, until a micropattern is actually lithographed after a base pattern acting as a reference is detected, since probe 13 is not moved for a long time and in a long distance, an alignment accuracy in the probe lithography technology can be improved.

Note that when the base pattern is detected, an optical alignment to substrate 12 may be dependently used. For example, when the base pattern is detected by probe 13 after the optical alignment to substrate 12 is executed, a more accurate alignment can be realized.

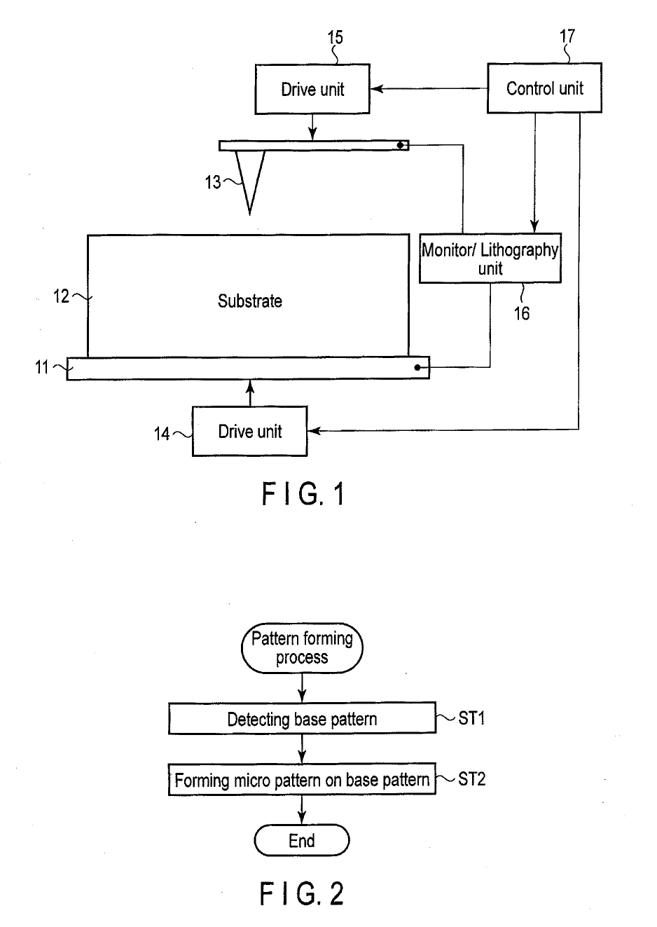

FIG. 2 shows a pattern forming process using the pattern forming apparatus of FIG. 1.

First, a base pattern is detected using a probe (step ST1).

Thereafter, at once, a micropattern is formed on the base pattern using a probe (step ST2).

For example, when the base pattern is an element which functions electrically such as a conductive wire, an electrode, and the like, the micropattern is an element such as a contact hole and the like which secures an electric connection to the base pattern. Further, when the base pattern is an alignment mark, the micropattern is an alignment mark formed directly above a base pattern.

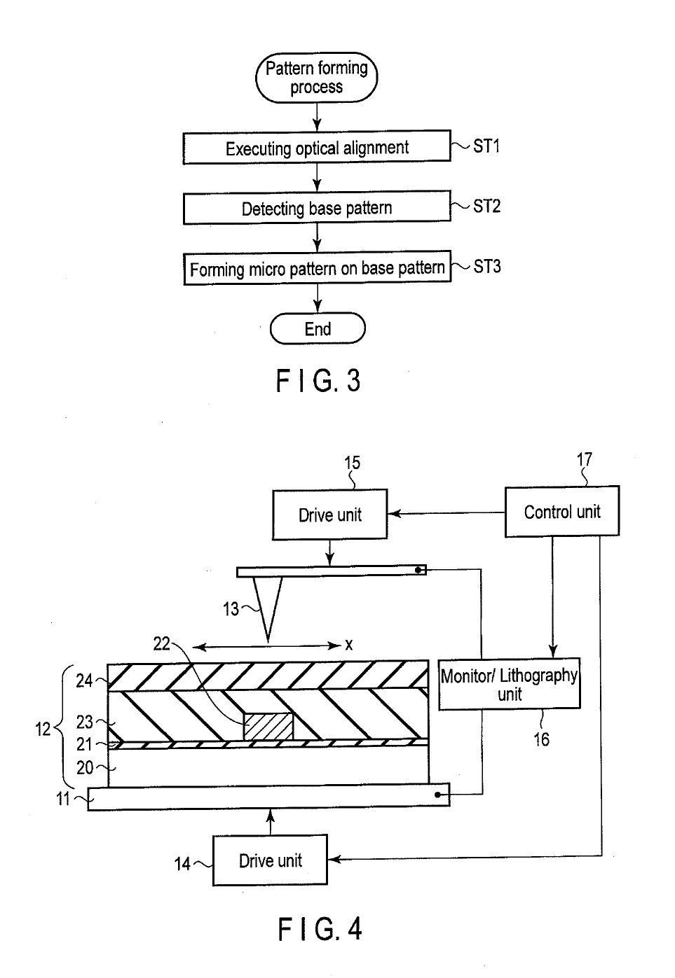

FIG. 3 shows a modification of the pattern forming process of FIG. 2.

First, an optical alignment is executed, and an approximate position of a base pattern in a substrate is found (step ST1).

Next, the base pattern is detected using a probe (step ST2).

Thereafter, at once, a micropattern is formed on the base pattern using the probe (step ST3).

Here, as a method of forming the micropattern by the probe, there is first a method of partially exposing a resist layer in a substrate (for example, an electron beam exposure method, and the like), a method of directly forming a pattern by depositing a material in an area directly above a base pattern (for example, Dip Pen Nanolithography method: DPN, and the like).

Thus, these methods will be explained below.

FIGS. 4 to 6 show a process which forms a micropattern to a resist layer.

Substrate (substrate to be processed) 12 is provided with semiconductor layer 20, insulation layer 21 on semiconductor layer 20, base pattern (for example, a conductive wire, an electrode, and the like) 22 on insulation layer 21, interlayer insulation layer 23 which covers base pattern 22, and resist layer 24 on interlayer insulation layer 23.

Since elements which configure the pattern forming apparatus, for example, stage 11, probe 13, drive units 14, 15, monitor/lithography unit 16, and control unit 17 are already explained, an explanation thereof here is omitted.

In the example, an example that a micropattern is formed to resist layer 24 using the pattern forming apparatus of FIG. 1 will be explained. The micropattern is, for example, a pattern of a contact hole.

First, as shown in FIG. 4, substrate 12 is mounted on stage 11. Further, at least one of stage 11 and probe 13 is driven using drive units 14, 15, and probe 13 is scanned along an upper surface of substrate 12.

For example, probe 13 is scanned in an x-direction away from the upper surface of substrate 12, here from an upper surface of resist layer 24. Further, a capacitance between stage 11 and probe 13 is measured while scanning probe 13 in the x-direction. In the case, when probe 13 is provided in an area directly above base pattern 22, as shown in FIG. 5, the capacitance C between stage 11 and probe 13 increases.

Accordingly, base pattern 22 can be detected by measuring the capacitance between stage 11 and probe 13. Data of base pattern 22 is stored in a memory in, for example, control unit 17.

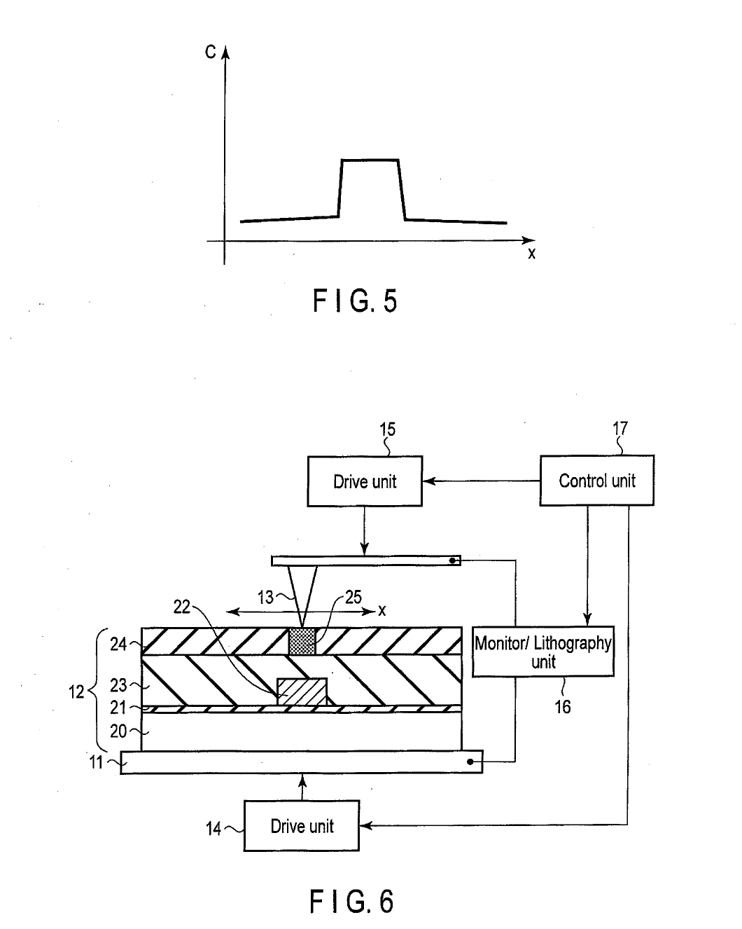

Next, as shown in FIG. 6, probe 13 is moved in the area directly above base pattern 22 again based on the data of base pattern 22.

That is, this time, probe 13 is scanned in the x-direction in contact with the upper surface of substrate 12, here, with the upper surface of resist layer 24. At the time, resist layer 24 is partially exposed by controlling the voltage applied between stage 11 and probe 13, and micropattern (exposure area) 25 is formed to resist layer 24.

For example, when resist layer 24 is exposed, the voltage is applied between stage 11 and probe 13, and resist layer 24 is exposed by electrons discharged from probe 13. In a case other than the above-mentioned, no voltage is applied between stage 11 and probe 13.

With the process described above, micropattern (exposure area) 25 can be formed to resist layer 24 directly above base pattern 22.

Note that, thereafter, resist layer 24 is developed. Then, when interlayer insulation layer 23 is etched by, for example, RIE (reactive ion etching) using resist layer 24 as a mask, a contact hole is formed on base pattern 22.

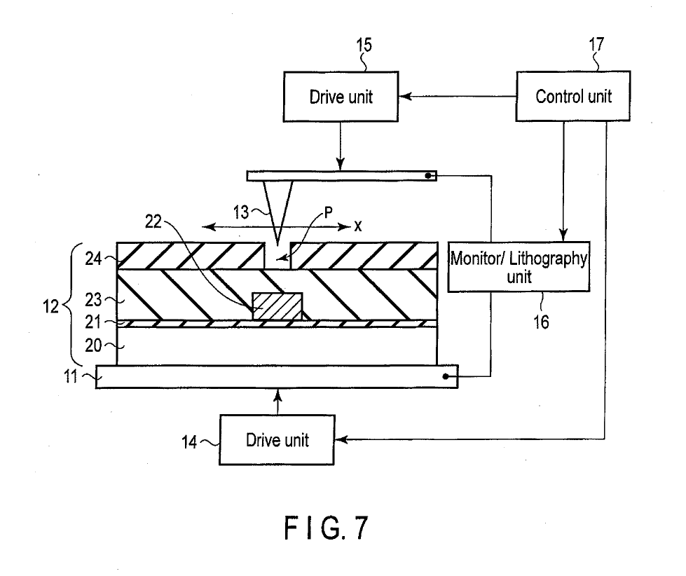

FIG. 7 shows a process which directly forms a micropattern.

Substrate (substrate to be processed) 12 is provided with semiconductor layer 20, insulation layer 21 on semiconductor layer 20, base pattern (for example, a conductive wire, an electrode, and the like) 22 on insulation layer 21, and interlayer insulation layer 23 which covers base pattern 22.

Since elements which configure the pattern forming apparatus, for example, stage 11, probe 13, drive units 14, 15, monitor/lithography unit 16, and control unit 17 are already explained, an explanation thereof here is omitted.

In the example, an example that a micropattern P is directly formed by depositing a material on interlayer insulation layer 23 by DPN and the like using the pattern forming apparatus of FIG. 1 will be explained. The micropattern is, for example, a pattern of a contact hole.

First, substrate 12 is mounted on stage 11. Further, at least one of stage 11 and probe 13 is driven using drive units 14, 15, and probe 13 is scanned along an upper surface of substrate 12.

For example, probe 13 is scanned in the x-direction away from an upper surface of substrate 12, here, from an upper surface of interlayer insulation layer 23. Further, a capacitance between stage 11 and probe 13 is measured while scanning probe 13 in the x-direction. In the case, when probe 13 is provided in the area directly above base pattern 22, as shown in FIG. 5, the capacitance C between stage 11 and probe 13 increases.

Accordingly, base pattern 22 can be detected by measuring the capacitance between stage 11 and probe 13. Data of base pattern 22 is stored in the memory in, for example, control unit 17.

Next, probe 13 is moved in the area directly above base pattern 22 again based on the data of base pattern 22.

That is, probe 13 is scanned in the x-direction away from the upper surface of substrate 12, here, from the upper surface of interlayer insulation layer 23. At the time, resist layer 24 having a micropattern P can be formed by partially dropping resist layer 24 from probe 13 onto interlayer insulation layer 23.

With the process described above, an area in which no resist layer 24 is formed, that is, the micropattern P can be formed directly above base pattern 22.

Note that, thereafter, when interlayer insulation layer 23 is etched by, for example, RIE using resist layer 24 as a mask, the contact hole is formed on base pattern 22.

As described above, when the pattern forming apparatus according to the first embodiment is used, the alignment accuracy in the probe lithography technology (Overlay accuracy: OL accuracy) can be improved. For example, an alignment accuracy of less than ±3 nm can be realized between a base pattern having a width of about 10 nm and a micropattern formed directly above the base pattern.

### 2. Second Embodiment

A second embodiment relates to a pattern forming apparatus which can form a micropattern (first pattern) in an area directly above a base pattern (second pattern) by one of two probes being adjacent to each other in parallel with that the other one of the two probes detects the base pattern.

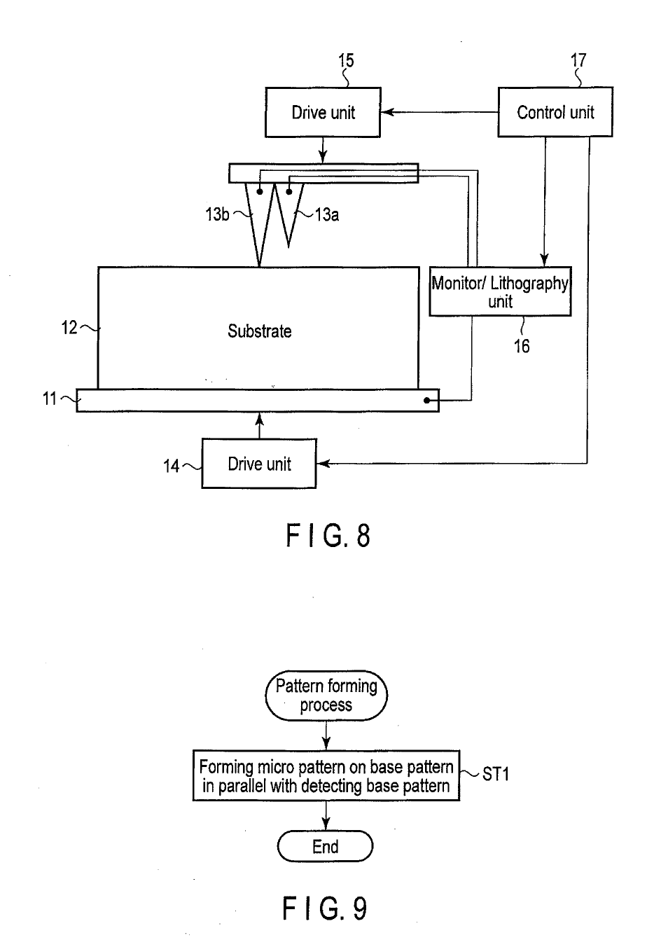

FIG. 8 shows the second embodiment of the pattern forming apparatus.

Stage 11 is provided under a lower surface of substrate (substrate to be processed) 12. Stage 11 has a function which supports substrate 12 and applies a fixed potential (for example, positive potential) to the lower surface of substrate 12. Substrate 12 is, for example, a semiconductor wafer.

Probes 13a, 13b are provided above an upper surface of substrate 12. Probes 13a, 13b are provided adjacent to each other and electrically insulated from each other. Although probes 13a, 13b have, for example, a cantilever type, they are not limited thereto.

Drive units 14, 15 drive at least one of stage 11 and probes 13a, 13b. When only stage 11 is driven, drive unit 15 may be omitted. Further, when only probes 13a, 13b are driven, drive unit 14 may be omitted. Naturally, both stage 11 and probes 13a, 13b may be driven using drive units 14, 15. When probes 13a, 13b are driven, probes 13a, 13b execute the same movement.

Drive unit 14 drives stage 11. For example, drive unit 14 two-dimensionally drives stage 11. However it is also possible to drive stage 11 by drive unit 14 one-dimensionally or three-dimensionally.

Drive unit 15 drives probes 13a, 13b. For example, drive unit 15 drives probes 13a, 13b three-dimensionally. However, it is also possible to drive probes 13a, 13b by drive unit 15 one-dimensionally or two-dimensionally.

Monitor/lithography unit 16 is electrically connected to probes 13a, 13b to detect a base pattern in substrate 12 and to form a micropattern in an area directly above the base pattern. For example, monitor/lithography unit 16 detects the base pattern in substrate 12 by detecting a capacitance between stage 11 and probe 13a.

When the base pattern is detected by the capacitance, monitor/lithography unit 16 applies an alternate current between, for example, stage 11 and probe 13a and detects its current waveform. Further, when the micropattern is formed, monitor/lithography unit 16 applies a voltage between, for example, stage 11 and probe 13b.

Note that it is also possible to detect the base pattern by a physical factor other than the capacitance, for example, a surface potential, a magnetic field, and the like.

Control unit 17 controls drive units 14, 15 and monitor/lithography unit 16. Control unit 17 changes a relative position between substrate 12 and probes 13a, 13b. For example, control unit 17 controls drive units 14, 15 so that probes 13a, 13b execute scanning linearly to substrate 12.

Further, control unit 17 forms the micropattern in the area directly above the base pattern by probe 13b in parallel with that control unit 17 detects the base pattern in substrate 12 by probe 13a.

What is important here is to lithograph the micropattern in an area directly above a base pattern, which is detected by probe 13a, by probe 13b. That is, a position directly above a base pattern can be detected and a micropattern can be formed directly above the base pattern.

With the operation, since probes 13a, 13b are not moved for a long time and in a long distance until the micropattern is actually lithographed after the base pattern acting as a reference is detected, the alignment accuracy in the probe lithography technology can be improved.

Note that when the base pattern is detected, an optical alignment to substrate 12 may be dependently used. For example, when the base pattern is detected by probe 13a after the optical alignment to substrate 12 is executed, a more accurate alignment can be realized.

FIG. 9 shows a pattern forming process using the pattern forming apparatus of FIG. 8.

A feature of the process resides in that a micropattern is formed on a base pattern by probe 13b in parallel with that the base pattern is detected by probe 13a (step ST1).

That is, since probe 13a which detects the base pattern and probe 13b which forms the micropattern are provided adjacent to each other, the micropattern can be formed on the base pattern in parallel with that the base pattern is detected.

Note that when the base pattern is an element which functions electrically such as a conductive wire, an electrode, and the like, the micropattern is an element which secures an electric connection to the base pattern such as a contact hole and the like. Further, when the base pattern is an alignment mark, the micropattern is an alignment mark formed directly above the base pattern.

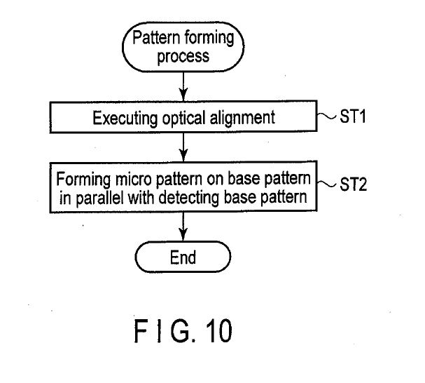

FIG. 10 shows a modification of the pattern forming process of FIG. 9.

First, an optical alignment is executed, and an approximate position of a base pattern in a substrate is found (step ST1).

Thereafter, a micropattern is formed on the base pattern by probe 13b in parallel with that the base pattern is detected by probe 13a (step ST2).

Here, as a method of forming the micropattern by the probe, there is first a method of partially exposing a resist layer in a substrate (for example, an electron beam exposure method, and the like), a method of directly forming a pattern in an area directly above a base pattern (for example, DPN, and the like). Since samples of these methods are already explained in the first embodiment, an explanation thereof here is omitted.

### 3. Third Embodiment

A third embodiment relates to a pattern forming apparatus which can form a micropattern (first pattern) in an area different from directly above a base pattern by one of two probes being arranged in a constant interval in parallel with that a base pattern (second pattern) is detected by the other one of the two probes.

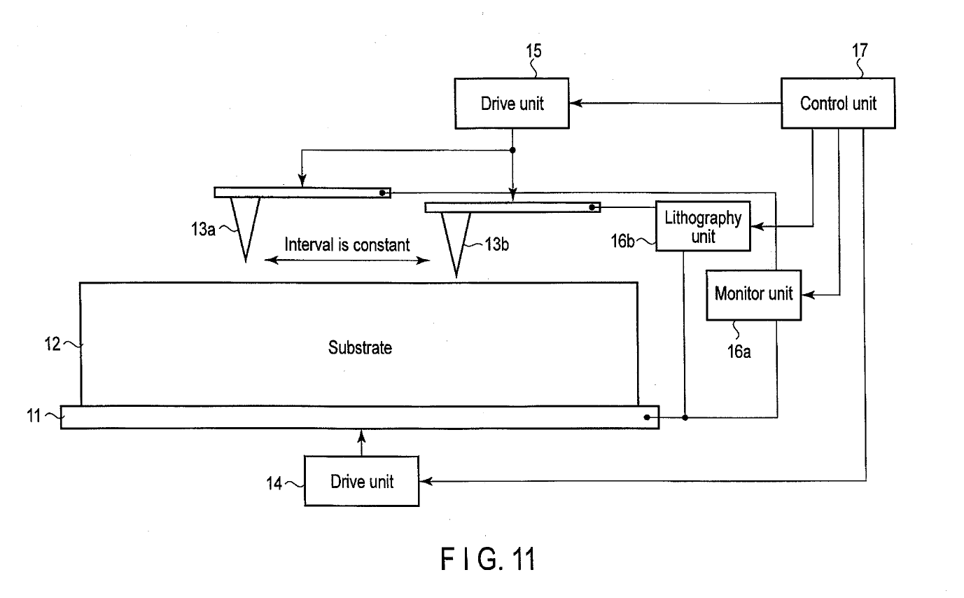

FIG. 11 shows the third embodiment of the pattern forming apparatus.

Stage 11 is provided under a lower surface of substrate (substrate to be processed) 12. Stage 11 has a function which supports substrate 12 and applies a fixed potential (for example, positive potential) to a lower surface of substrate 12. Substrate 12 is, for example, a semiconductor wafer.

Probes 13a, 13b are provided above an upper surface of substrate 12. Probes 13a, 13b are provided away from each other at a constant interval and electrically insulated from each other. Although probes 13a, 13b have, for example, a cantilever type, respectively, they are not limited thereto.

Drive units 14, 15 drive at least one of stage 11 and probes 13a, 13b. When only stage 11 is driven, drive unit 15 may be omitted. Further, when only probes 13a, 13b are driven, drive unit 14 may be omitted. Naturally, both stage 11 and probes 13a, 13b may be driven using drive units 14, 15. When probes 13a, 13b are driven, probes 13a, 13b execute the same movement.

Drive unit 14 drives stage 11. For example, drive unit 14 two-dimensionally drives stage 11. However it is also possible to drive stage 11 by drive unit 14 one-dimensionally or three-dimensionally.

Drive unit 15 drives probes 13a, 13b. For example, drive unit 15 drives probes 13a, 13b three-dimensionally. However, it is also possible to drive probes 13a, 13b by drive unit 15 one-dimensionally or two-dimensionally.

Monitor unit 16a is electrically connected to probe 13a to detect a base pattern in substrate 12. For example, monitor unit 16a detects the base pattern in substrate 12 by detecting a capacitance between stage 11 and probe 13a. When the base pattern is detected by the capacitance, monitor unit 16a applies an alternate current between, for example, stage 11 and probe 13a and detects its current waveform.

Note that it is also possible to detect the base pattern by a physical factor other than the capacitance, for example, a surface potential, a magnetic field, and the like.

Lithography unit 16b is electrically connected to probe 13b to form a micropattern in an area directly above the base pattern. When the micropattern is formed, lithography unit 16b applies a voltage between, for example, stage 11 and probe 13b.

Control unit 17 controls drive units 14, 15, monitor unit 16a, and lithography unit 16b. Control unit 17 changes a relative position between substrate 12 and probes 13a, 13b. For example, control unit 17 controls drive units 14, 15 so that probes 13a, 13b execute scanning linearly to substrate 12.

Further, control unit 17 forms the micropattern in the area different from directly above the base pattern by probe 13b in parallel with that control unit 17 detects the base pattern in substrate 12 by probe 13a.

What is important here is to lithograph the micropattern by probe 13b at the same time that the base pattern is detected by probe 13a. With the operation, since probes 13a, 13b are not moved for a long time and in a long distance until the micropattern is actually lithographed after the base pattern acting as a reference is detected, the alignment accuracy in the probe lithography technology can be improved.

Note that when the base pattern is detected, an optical alignment to substrate 12 may be dependently used. For example, when the base pattern is detected by probe 13a after the optical alignment to substrate 12 is executed, a more accurate alignment can be realized.

Further, a pattern forming process using the pattern forming apparatus of FIG. 11 is as shown in FIGS. 9 and 10 likewise the second embodiment. Accordingly, an explanation of the pattern forming process is omitted. The base pattern may be an element which functions electrically such as a conductive wire, an electrode, and the like or may be an alignment mark.

The embodiment is different from first and second embodiments described above in a position of the base pattern and in a position of the micropattern. Accordingly, it is necessary to correct a relation between the base pattern detected by probe 13a and the micropattern formed by probe 13b based on a position, a size, a shape, and the like of an actually formed micropattern.

For example, the interval (a value of the constant interval) of probes 13a, 13b, a position of probe 13b when the micropattern is formed, and the like are adjusted based on the position, a size, a shape, and the like of the micropattern.

Accordingly, in the embodiment, after the micropattern is formed, the actually formed micropattern is detected by probe 13a.

An example of the detection of the micropattern will be explained below.

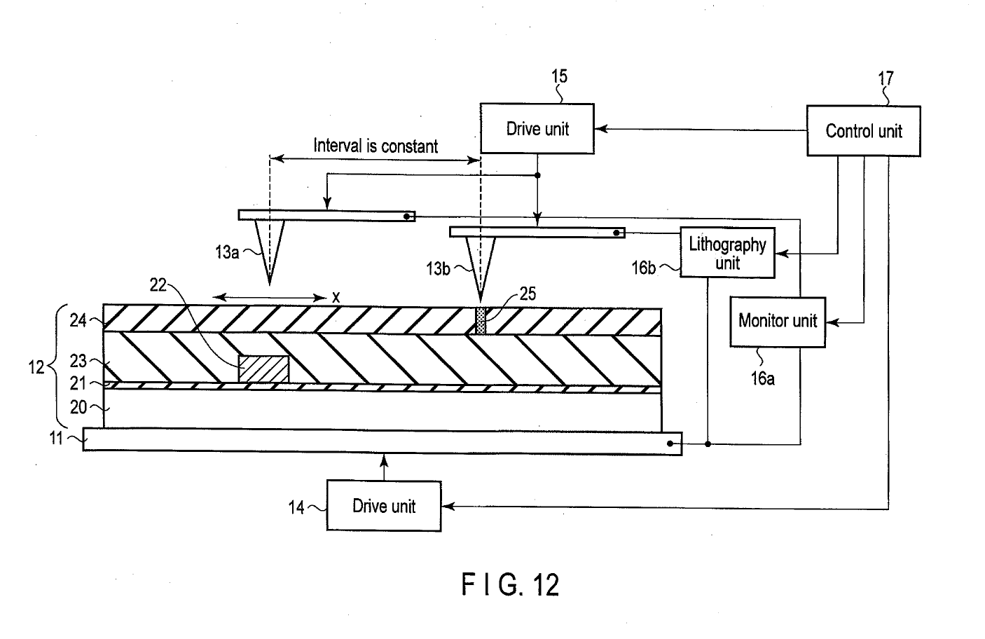

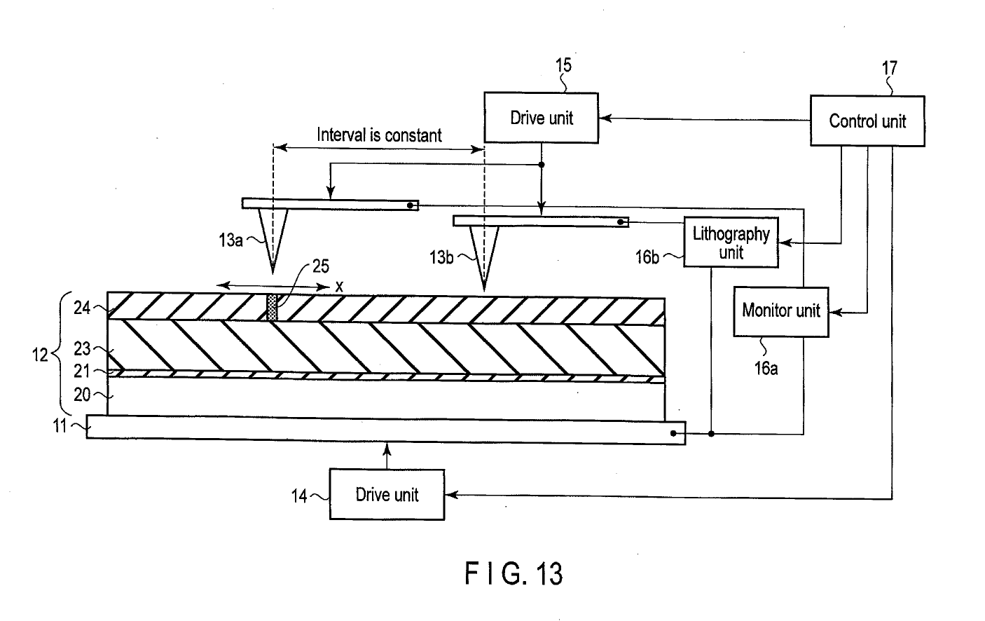

FIGS. 12 and 13 show a process which forms the micropattern to a resist layer.

Substrate (substrate to be processed) 12 is provided with semiconductor layer 20, insulation layer 21 on semiconductor layer 20, base pattern (for example, an alignment mark and the like) 22 on insulation layer 21, interlayer insulation layer 23 which covers base pattern 22, and resist layer 24 on interlayer insulation layer 23.

Since elements which configure the pattern forming apparatus, for example, stage 11, probes 13a, 13b, drive units 14, 15, monitor unit 16a, lithography unit 16b, and control unit 17 are already explained, an explanation thereof here is omitted.

In the example, an example will be explained which forms a micropattern to resist layer 24 using the pattern forming apparatus of FIG. 11 and the positions and the interval of probes 13a, 13b are adjusted by detecting the micropattern again.

First, as shown in FIG. 12, substrate 12 is mounted on stage 11. Further, at least one of stage 11 and probes 13a, 13b is driven using drive units 14, 15, and probes 13a, 13b are scanned along the upper surface of substrate 12.

For example, a capacitance between stage 11 and probe 13a is measured while scanning probe 13a in the x-direction. In the case, when probe 13a is provided in the area directly above base pattern 22, as shown in FIG. 5, the capacitance C between stage 11 and probe 13a increases.

Accordingly, base pattern 22 can be detected by measuring the capacitance between stage 11 and probe 13a.

In parallel with the operation, resist layer 24 is partially exposed and micropattern (exposure area) 25 is formed to resist layer 24 by controlling a voltage applied between stage 11 and probe 13b.

For example, when resist layer 24 is exposed, the voltage is applied between stage 11 and probe 13b, and resist layer 24 is exposed by electrons discharged from probe 13b. In a case other than the above-mentioned, no voltage is applied between stage 11 and probe 13b.

With the process described above, micropattern (exposure area) 25 can be formed to resist layer 24 directly above base pattern 22.

Next, as shown in FIG. 13, a position, a size, a shape, and the like of actually formed micropattern 25 are detected by probe 13a.

For example, when micropattern 25 is an exposure area of resist layer 24, micropattern 25 can be detected by measuring slight irregularities of a surface of the exposure area due to exposure, a change of capacitance due to a chemical change of the exposure area, and further a friction force (friction force when scanned by probe 13a) between the exposure area and an area other than the exposure area, and the like.

Further, micropattern 25 may be directly detected by a method of an image processing and the like.

Then, elements such as the position, the size, the shape, and the like of the micropattern as target values are compared with elements such as the position, the size, the shape, and the like of the actually formed, and the interval (the value of the constant interval) of probes 13a, 13b, the positions of probe 13b when the micropattern is formed, and the like are adjusted based on a relation therebetween.

According to the embodiment, it is possible to correct the position, the size, the shape, and the like of the micropattern at real time while probes 13a, 13b are being scanned, that is, while the base pattern is being detected or while the micropattern is being lithographed.

For example, when stage 11, probes 13a, 13b, and the like are time-degraded and further a material (a resist or the like) is injected from probe 13b, the embodiment can cope with also a change of size and shape of the micropattern and the like due to a variation with time of material characteristics and an injection amount and due to a shortage of material and clogging of material.

Note that it is needless to say that the same effect as that described above can be obtained also in the process which directly forms the micropattern (refer to, for example, FIG. 7).

### 4. Conclusion

According to the embodiments, the alignment accuracy in the probe lithography technology can be improved. Further, since an accurate alignment can be realized without an alignment mark, it is also possible to omit the alignment mark. Accordingly, a reduction of TAT (turn around time), a reduction of manufacturing cost, and the like can be also achieved. However, it is naturally possible to combine the alignment according to the embodiment with the optical alignment by the alignment mark.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A pattern forming apparatus comprising:
a stage provided under a lower surface of a substrate;
a probe provided above an upper surface of the substrate;
a drive unit which drives at least one of the stage and the probe;
a monitor/lithography unit connected to the probe; and
a control unit which controls the drive unit and the monitor/lithography unit,
wherein the control unit is configured to change a relative position between the probe and the substrate, and form a first pattern in an area direct above a second pattern after detecting the second pattern in the substrate by the probe.

2. The apparatus of claim 1,
wherein the second pattern is detected by the probe after executing an optical alignment to the substrate.

3. The apparatus of claim 1,
wherein the second pattern is detected by measuring a capacitance between the probe and the substrate.

4. The apparatus of claim 1,
wherein the first pattern is formed by exposing a resist layer in the substrate partially using the probe.

5. The apparatus of claim 1,
wherein the first pattern is direct formed by depositing a material in an area direct above the second pattern using the probe.

6. A pattern forming apparatus comprising:
a stage provided under a lower surface of a substrate;
first and second probes provided above an upper surface of the substrate, the first and second probes being adjacent to each other;
a drive unit which drives at least one of the stage and the first and second probes;
a monitor unit connected to the first probe;
a lithography unit connected to the second probe; and
a control unit which controls the drive unit, the monitor unit and the lithography unit,
wherein the control unit is configured to change a relative position between the first and second probes and the substrate, and form a first pattern in an area direct above a second pattern by the second probe in parallel with detecting the second pattern in the substrate by the first probe.

7. The apparatus of claim 6,
wherein the second pattern is detected by the first probe after executing an optical alignment to the substrate.

8. The apparatus of claim 6,
wherein the second pattern is detected by measuring a capacitance between the first probe and the substrate.

9. The apparatus of claim 6,
wherein the first pattern is formed by exposing a resist layer in the substrate partially using the second probe.

10. The apparatus of claim 6,
wherein the first pattern is direct formed by depositing a material in an area direct above the second pattern using the second probe.

11. A pattern forming apparatus comprising:
a stage provided under a lower surface of a substrate;
first and second probes provided above an upper surface of the substrate, the first and second probes being arranged in a constant interval;
a drive unit which drives at least one of the stage and the first and second probes;
a monitor unit connected to the first probe;
a lithography unit connected to the second probe; and
a control unit which controls the drive unit, the monitor unit and the lithography unit,
wherein the control unit is configured to change a relative position between the first and second probes and the substrate, and form a first pattern in an area different from an area direct above a second pattern by the second probe in parallel with detecting the second pattern in the substrate by the first probe.

12. The apparatus of claim 11,
wherein the second pattern is detected by the first probe after executing an optical alignment to the substrate.

13. The apparatus of claim 11,
wherein the second pattern is detected by measuring a capacitance between the first probe and the substrate.

14. The apparatus of claim 11,
wherein the first pattern is formed by exposing a resist layer in the substrate partially using the second probe.

15. The apparatus of claim 11,
wherein the first pattern is direct formed by depositing a material in an area direct above the second pattern using the second probe.

16. The apparatus of claim 11,
wherein the control unit is configured to detect the first pattern by the first probe after forming the first pattern.

17. The apparatus of claim 16,
wherein the control unit is configured to correct a value of the constant interval based on a position and a size of the first pattern.

18. A method of forming a first pattern based on a second pattern, the method comprising:
changing a relative position between a probe and a substrate; and
forming the first pattern in an area direct above the second pattern after detecting the second pattern in the substrate by the probe.

19. A method of forming a first pattern based on a second pattern, the method comprising:
changing a relative position between first and second probes and a substrate; and
forming the first pattern in an area direct above the second pattern by the second probe in parallel with detecting the second pattern in the substrate by the first probe.

20. A method of forming a first pattern based on a second pattern, the method comprising:
changing a relative position between first and second probes and a substrate; and
forming the first pattern in an area different from an area direct above the second pattern by the second probe in parallel with detecting the second pattern in the substrate by the first probe.
